(19) United States
(12) Patent Application Publication
(10) Pub. No.: US 2018/0024909 A1
(43) Pub. Date: Jan. 25, 2018

(54) MONITORING GROWTH OF MEMORY BUFFERS IN LOGGING AND DYNAMICALLY ADAPTING QUANTITY AND DETAIL OF LOGGING

(71) Applicant: International Business Machines Corporation, Armonk, NY (US)

(72) Inventors: Scott J. Broussard, Cedar Park, TX (US); Thangadurai Muthusamy, Bangalore (IN); Amartey S. Pearson, Austin, TX (US); Rejy V. Sasidharan, Bangalore (IN)

(21) Appl. No.: 15/218,161

(22) Filed: Jul. 25, 2016

(51) Int. Cl. G06F 11/36

(52) U.S. Cl. CPC G06F 11/362

(57) ABSTRACT

Computer implemented methods for monitoring growth of memory buffers in logging and dynamically adapting quantity and detail of logging. In one method, a computer determines whether an operation of a thread has a failure and whether the failure is severe and logs details from a pre-thread logging buffer. In another method, a computer calculates an increase in a log buffer size, reads from a configuration file a maximum allowed increase in the log buffer size, and returns logging details, in response to determining that the increase is more than the maximum allowed increase. In yet another method, a computer writes a log of a use case to a disk, calculates an actual size of the log in the database, and returns logging details, in response to determining that the actual size is more than the allowed size.

### BACKGROUND

The present invention relates generally to logging in developing and debugging applications, and more particularly to monitoring growth of memory buffers in logging and dynamically adapting quantity and detail of logging.

In many legacy applications, very low level log statements get introduced while developing and debugging application defects over time. If the log messages do not have correct logging levels, then they will cause lot of noise in log files and hamper effectiveness of using logs to triage defects. If an excessive amount of data is logged, then the rate of log files getting wrapped over time will be increased and the retention of required information in log files will be significantly reduced. The excessive amount of data also causes an increase in requests for re-creating a defects to get required information in log files by development teams. Although the development teams can follow logging best practices to keep sanity of log messages, it is not practical to manually keep track of excessive logging introduced over time.

Logging into a memory buffer, especially a circular buffer, is used in many applications to reduce number of disk I/O and dynamically decide whether the contents of a memory buffer should be flushed to disk, based on success or failure of program flows. Several logging frameworks, such as Java-based logging utilities Apache log 4j and Logback, provide circular buffer appenders for logging application data into memory buffers. Currently, there is no mechanism available to automatically keep track of excessive logging introduced by an application and warn application developers when excessive logging is introduced.

### SUMMARY

A computer implemented method for monitoring growth of memory buffers in logging and dynamically adapting quantity and detail of logging is provided. The method is implemented by a computer. The method includes starting a per-thread logging buffer, in response to determining that a thread starts an operation of a task; determining whether the operation has a failure, in response to determining that the operation completes; determining whether the failure is severe, in response to determining that the operation has the failure; and logging details from the per-thread logging buffer, in response to determining that the failure is severe.

A computer implemented method for monitoring growth of memory buffers in logging and dynamically adapting quantity and detail of logging is provided. The method is implemented by a computer. The method includes calling a log buffer to get buffered data, in response to determining that a use case completes; calculating an increase in a size of the log buffer; retrieving from a configuration file, a maximum allowed increase in the size of the log buffer; determining whether the increase is more than the maximum allowed increase; and returning logging details, in response to determining that the increase is more than the maximum allowed increase.

A computer implemented method for monitoring growth of memory buffers in logging and dynamically adapting quantity and detail of logging is provided. The method is implemented by a computer. The method includes writing a log of a use case to a disk, in response to determining that the use case completes; calculating an actual size of the log on the disk; determining whether the actual size is more than an allowed size; and returning logging details, in response to determining that the actual size is more than the allowed size.

### BRIEF DESCRIPTION OF THE SEVERAL VIEWS OF THE DRAWINGS

FIG. 1 is a flowchart illustrating operational steps of a logging engine managing a per-thread logging buffer for logging messages, in accordance with one embodiment of the present invention.

FIG. 2 is a flowchart showing operational steps for measuring the size of log messages written to a memory buffer, in accordance with one embodiment of the present invention.

FIG. 3 is a flowchart showing operational steps for measuring the size of log files written to a disk, in accordance with one embodiment of the present invention.

FIG. 4 is a diagram illustrating components of a computer device hosting a computer program for monitoring growth of memory buffers in logging and dynamically adapting quantity and detail of logging, in accordance with one embodiment of the present invention.

### DETAILED DESCRIPTION

The embodiments of the present invention establish automated mechanisms for monitoring logging and identifying when excessive logging occurs by comparing to an established benchmark. The dynamic autonomic mechanisms adapt the level of logging based on the operational context.

In the embodiments of the present invention, the proposed solutions are software based methodology. The proposed solutions monitor the growth of memory buffers used for logging and dynamically adapt the quantity and detail of the logging to meet the operational needs. When an application use case is executed, the automated mechanisms are used to measure the consumption of memory buffers or log files that are holding log messages. The measurements of the consumption are repeated and compared against previous measurements done for respective use cases. During the build (or post build verification tests), the use cases are executed and the consumption of memory buffers or log files is measured. The measurements of the consumption are compared against previous values stored by the testing framework. If the growth in the consumption of memory buffers or log files exceeds a predetermined threshold value, then tests either fail or provide warning messages. The automated mechanisms help avoid or reduce excessive logging in applications by automatically detecting sudden increases in log messages while performing post build verification tests. The automated mechanisms may be extended to include filters on a component or package level; therefore, the automated mechanisms do not only identify that excessive logging takes place, but also identify a component or package that is responsible for the increase.

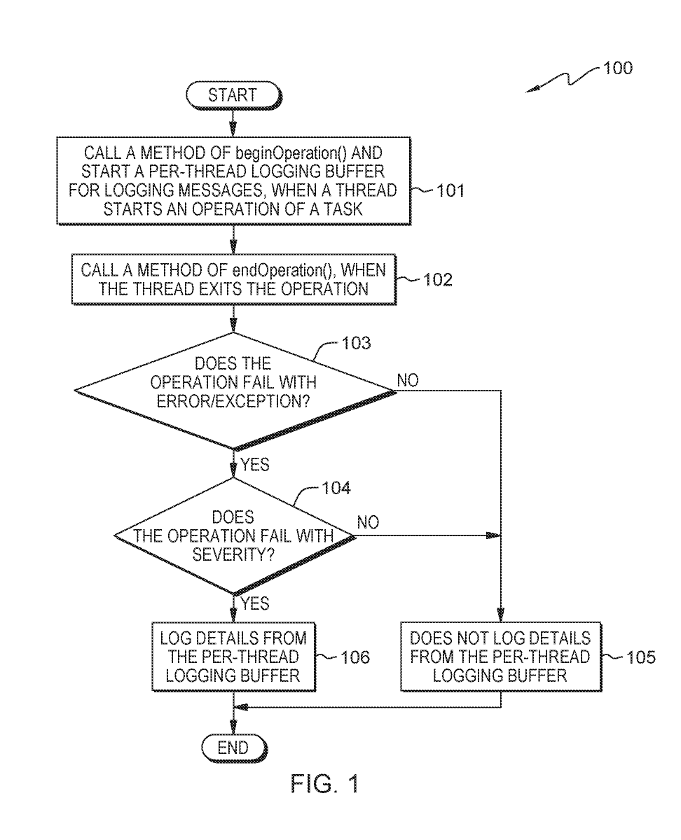

In an embodiment of the present invention, a logging engine manages a per-thread logging buffer for logging messages. The per-thread logging buffer captures detailed messages; however, the logging engine emits the detailed messages from the per-thread logging buffer to a log file when a significant error occurs during the operation of a use case. FIG. 1 is flowchart 100 illustrating operational steps of a logging engine managing a per-thread logging buffer for logging messages, in accordance with one embodiment of the present invention.

The logging engine introduces a beginOperation( ) method and an endOperation( ) method that demarcate boundaries where a use case begins and ends. These are entry and exit points to an application, such as incoming WEB or REST API requests, incoming CLI requests, incoming events, and other inter-process communications. At step 101, when a thread starts an operation of a task, a logging engine calls the beginOperation( ) method and starts a pre-thread logging buffer for logging messages. When a logging API is called after the beginOperation( ) is called, the log messages are put into the per-thread log buffer. As configured, the logging messages are buffered for performance and interleaved with other operations from other threads as expected. However, the lower level log statements that are normally excluded from logging based on the configuration are retailed per-thread. At step 102, the logging engine calls the endOperation( ) method when the thread exists the operation. At step 103, the logging engine determines whether the operation fails with error/exception. In response to determining that the operation does not fail with error/exception (NO branch of step 103), at step 105, the logging engine does not log details from the pre-thread logging buffer to a log file. This is a success path and the logging engine may log the operation as successful.

In response to determining that the operation fails with error/exception (YES branch of step 103), at step 104, the logging engine further determines whether the operation fails with severity. In response to determining that the operation does not fail with severity (NO branch of step 104), at step 105, the logging engine does not log details from the pre-thread logging buffer to a log file. In response to determining that the operation fails with severity (YES branch of step 104), at step 106, the logging engine log details from the pre-thread logging buffer to a log file. At step 106, the logging engine can emit the lower level detailed logging information that it has captured in the per-thread buffer for that thread of execution.

The details logs may be out-of-time-sequence with other logs and therefore can be emitted into the log file in an indented way or other ways indicating that they are out of position. The log file may also show all messages from that thread, not just the detailed ones; this allows for minimal output to a log file when a use case runs normally without error. When an error occurs, the detailed level of logs is emitted to the log file. The log file helps developers with First Failure Data Capture (FFDC) and helps avoid having to attempt a re-create on the problem.

To complete a use case, there are different ways of using threads. (1) A single thread completes the execution of an entire use case, when the single thread returns the use case completes or the endOperation( ) method is called. (2) A main thread spawns one or more child threads. When all the child threads complete and the main thread also completes, the use case execution is completed. The main thread and the all child threads share the same memory buffer for logging. When the main thread returns, the use case completes. (3) If a producer-consumer design pattern or a thread pool is used for implementing the code, then measuring memory buffer usage for a single use case is not possible. However, the cumulative memory buffer usage for a set of use cases is measured for logging. Data from many uses cases is combined into events that share the same consumer code. Each event can be tagged with some source information which can be used to distinguish which use case the event is related to. (4) For an asynchronous request and a response kind of applications, when a sequence of threads submit a request and an event or a response is received from an external process, a sequence of separate threads are used for processing of the event. If the request thread throws an exception due to failure, then the use case ends with error.

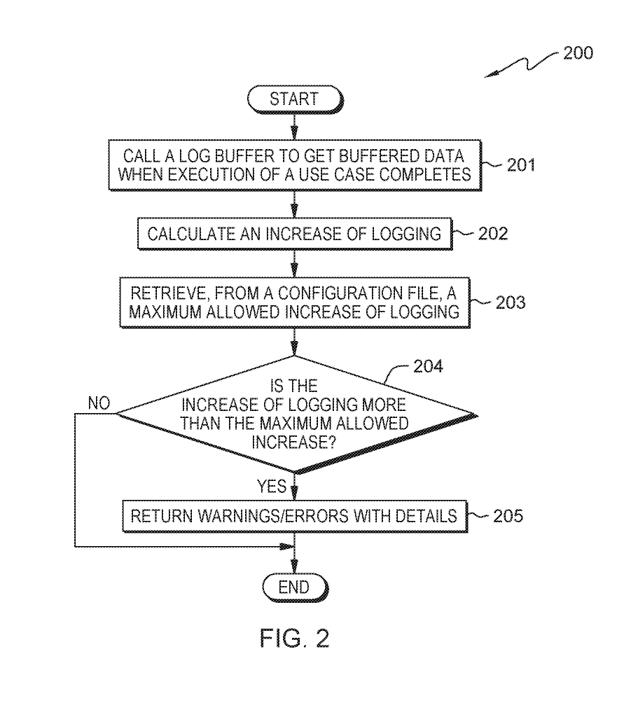

FIG. 2 is flowchart 200 showing operational steps for measuring the size of log messages written to a memory buffer, in accordance with one embodiment of the present invention. When execution of a use case or a transaction begins, a new memory buffer for logging is created. For example, the memory buffer is implemented as MX Bean (Management Bean) and can be queried by an external program or process to find out its size. At step 201, a post build verification script/program calls a log buffer when execution of the use case completes. When execution of a use case completes, the external program queries the logging memory buffer to find out the total size of logging done as part of the use case.

At step 202, the post build verification script/program calculates an increase of logging. In some embodiments, the increase is in term of percentage. The post build verification script/program has run multiple use cases, measured the size of logging for every use case, and stored the measured values in a persistent data store as a reference. The increase of the logging is determined based on the reference.

At step 203, the post build verification script/program retrieves, from a configuration file, a maximum allowed increase of logging. The configuration file with details on the maximum allowed increase in logging is defined in a post build verification script/program. In some embodiments, the maximum allowed increase of logging is in term of percentage. The post build verification script/program measures an increase in logging for the use case and compares the increase in logging with the maximum allowed percentage in the configuration file. At step 204, the post build verification script/program determines whether the increase of the logging is more than the maximum allowed increase.

In response to determining that the increase of the logging is more than the maximum allowed increase (YES branch of step 204), at step 205, the post build verification script/program returns warnings/errors with details. In response to determining that the increase of the logging is not more than the maximum allowed increase (NO branch of step 204), the post build verification script/program does not return warnings/errors with details. This helps developers or project managers to track how logging is changed for every build and also helps in minimizing or optimizing the logging. The embodiment of the present invention helps in automatically detecting excessive logging in early stage of application so that the logging is optimized before the application or product is shipped to customer.

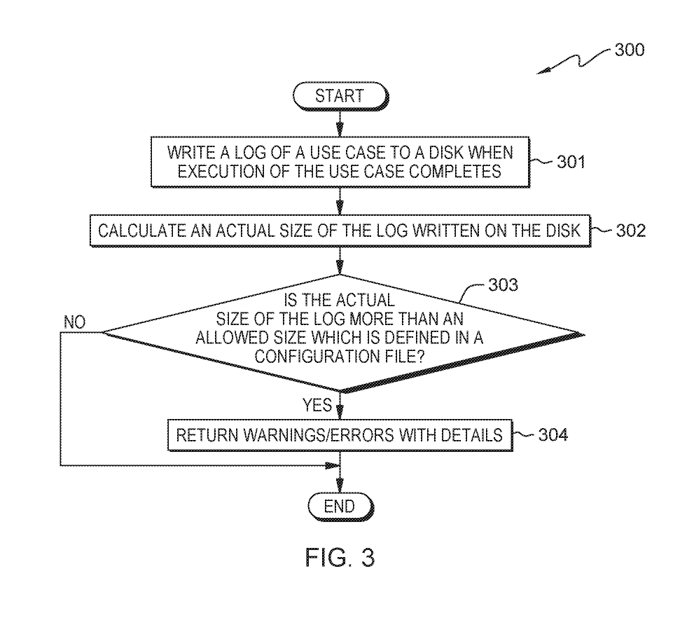

FIG. 3 is flowchart 300 showing operational steps for measuring the size of log files written to a disk, in accordance with one embodiment of the present invention. A post build verification script/program executes a set of use cases as defined in a configuration file and measures the size of logs written to a disk after execution completes. The measured size is stored in persistent storage as a reference. During next subsequent iterations of post build verification, the same set of use cases are executed and the size of logs written to the disk is measured and compared with previous measurements.

At step 301, the post build verification script/program writes a log of a use case to a disk when execution of the use case completes. At step 302, the post build verification script/program calculates an actual size of the log written on the disk. At step 303, the post build verification script/program determines whether the actual size of the log is more than an allowed size which is defined in a configuration file.

In response to determining that the actual size of the log is more than the allowed size (YES branch of step 303), at step 304, the post build verification script/program returns warnings/errors with details. In response to determining that the actual size of the log is not more than the allowed size (NO branch of step 303), the post build verification script/program does not return warnings/errors with details. This helps developers or project managers to track how logging is changed for every build and also helps in minimizing or optimizing the logging. The embodiment of the present invention helps in automatically detecting excessive logging in early stage of application so that the logging is optimized before the application or product is shipped to customer.

Memory buffer overflow during execution of a use case is handled as follows. When a memory buffer is about to get filled, it flushes the contents to a temporary disk file and keeps reference to this file. When use case completes (success or failure scenario), the post build verification script/program calculates the total consumed memory for logging by summing the contents of the memory buffer or the size of the temporary disk file.

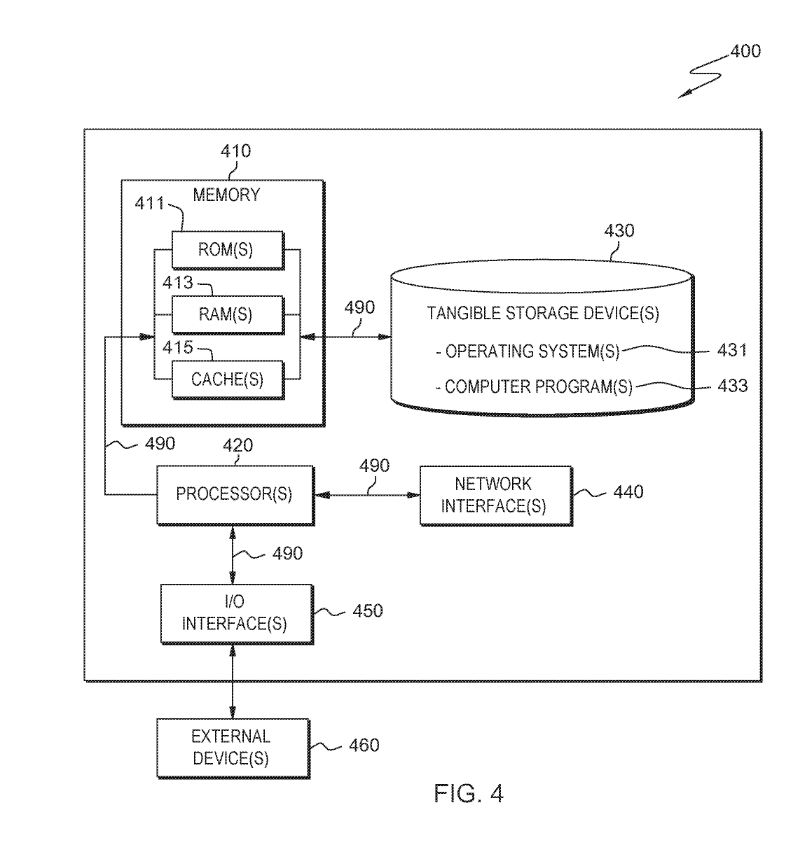

FIG. 4 is a diagram illustrating components of computer device 400 hosting a computer program for monitoring growth of memory buffers in logging and dynamically adapting quantity and detail of logging, in accordance with one embodiment of the present invention. It should be appreciated that FIG. 4 provides only an illustration of one implementation and does not imply any limitations with regard to the environment in which different embodiments may be implemented. The device may be any electronic device or computing system capable of receiving input from a user, executing computer program instructions, and communicating with another electronic device or computing system via a network.

Referring to FIG. 4, computer device 400 includes processor(s) 420, memory 410, and tangible storage device(s) 430. In FIG. 4, communications among the above-mentioned components of computer device 400 are denoted by numeral 490. Memory 410 includes ROM(s) (Read Only Memory) 411, RAM(s) (Random Access Memory) 413, and cache(s) 415. One or more operating systems 431 and one or more computer programs 433 reside on one or more computer readable tangible storage device(s) 430. One or more computer programs 433 include a computer program for monitoring growth of memory buffers in logging and dynamically adapting quantity and detail of logging. Computer device 400 further includes I/O interface(s) 450. I/O interface(s) 450 allows for input and output of data with external device(s) 460 that may be connected to computer device 400. Computer device 400 further includes network interface(s) 440 for communications between computer device 400 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for monitoring growth of memory buffers in logging and dynamically adapting quantity and detail of logging, the method comprising:
starting, by a computer, a per-thread logging buffer, in response to determining that a thread starts an operation of a task;
determining, by the computer, whether the operation has a failure, in response to determining that the operation completes;
determining, by the computer, whether the failure is severe, in response to determining that the operation has the failure; and
logging, by the computer, details from the per-thread logging buffer, in response to determining that the failure is severe.

2. The method of claim 1, further comprising:
in response to determining that the operation does not have the failure, logging, by the computer, the operation as successful, without logging the details from the per-thread logging buffer.

3. The method of claim 1, further comprising:
in response to determining that the failure is not severe, logging, by the computer, the operation as successful, without logging the details from the per-thread logging buffer.

4. The method of claim 1, further comprising:
calling, by the computer, a method of beginning the operation, in response to determining that the thread starts the operation of the task; and
calling, by the computer, a method of ending the operation, in response to determining that the thread exits the operation of the task.

5. The method of claim 1, wherein the thread spawns one or more child threads, wherein execution of a use case completes when the thread and the one or more child threads complete operations, wherein the thread and the child threads share the per-thread logging buffer.

6. The method of claim 1, wherein cumulative memory buffer usage for multiple use cases is measured for logging in the per-thread logging buffer, wherein each of the multiple use cases is tagged in the logging.

7. A method for monitoring growth of memory buffers in logging and dynamically adapting quantity and detail of logging, the method comprising:
calling, by a computer, a log buffer to get buffered data, in response to determining that a use case completes;
calculating, by the computer, an increase in a size of the log buffer;
retrieving, by the computer, from a configuration file, a maximum allowed increase in the size of the log buffer;
determining, by the computer, whether the increase is more than the maximum allowed increase; and
returning, by the computer, logging details, in response to determining that the increase is more than the maximum allowed increase.

8. The method of claim 7, further comprising:
in response to determining that the increase is not more than the maximum allowed increase, returning, by the computer, without the logging details.

9. The method of claim 7, further comprising:
running, by the computer, multiple use cases;
measuring, by the computer, a size of logging for every use case; and
storing, by the computer, measured values of sizes of logging in a persistent data store as a reference; and
wherein the increase in the size of the log buffer is determined based on the reference.

10. The method of claim 7, wherein the increase in the size of the log buffer and the maximum allowed increase are in term of percentage.

11. The method of claim 7, wherein the configuration file is defined in a post build verification program.

12. The method of claim 7, wherein the computer flushes contents in the log buffer to a temporary disk file when the log buffer is full, wherein the computer calculates a total consumed memory for logging by summing the contents in the log buffer and measuring a size of the temporary disk file.

13. A method for monitoring growth of memory buffers in logging and dynamically adapting quantity and detail of logging, the method comprising:
writing, by a computer, a log of a use case to a disk, in response to determining that the use case completes;
calculating, by the computer, an actual size of the log on the disk;
determining, by the computer, whether the actual size is more than an allowed size; and
returning, by the computer, logging details, in response to determining that the actual size is more than the allowed size.

14. The method of claim 13, further comprising:
in response to determining that the actual size is not more than the allowed size, returning, by the computer, without the logging details.

15. The method of claim 13, wherein the allowed size is defined in a configuration file.
